(19) United States
(12) Patent Application Publication
(10) Pub. No.: US 2017/0250958 A1
(43) Pub. Date: Aug. 31, 2017

(54) System and Method for Receiving and Relaying a Paging Message Via a Paging Proxy

(71) Applicant: Motorola Mobility LLC, Chicago, IL (US)

(72) Inventors: Wayne Ballantyne, Coconut Creek, FL (US); Roger W. Ady, Chicago, IL (US); Murali Narasimha, Vernon Hills, IL (US)

(21) Appl. No.: 15/595,563

(22) Filed: May 15, 2017

Related U.S. Application Data
(63) Continuation-in-part of application No. 14/920,279, filed on Oct. 22, 2015.
Application No. 14/920,279 is a continuation-in-part of application No. 15/084,552, filed on Mar. 30, 2016.

(51) Int. Cl. H04L 29/06; H04L 12/707; H04W 88/04

(52) U.S. Cl. CPC H04L 63/0281; H04W 88/04; H04L 45/22; H04W 36/0033

(57) ABSTRACT

The present invention provides a system and method for receiving and relaying a paging message via a paging proxy in a wide area wireless network. The system and method include detecting a proxy device for acting as a paging proxy near a present position of the mobile wireless communication device, where the proxy device includes a communication connection with a network paging controller, and is adapted to interact with the mobile wireless communication device separately from a wide area communication connection used by the mobile device to communicate with the wide area wireless network. The mobile wireless communication device is then associated with the proxy device for receiving and relaying an indication of paging messages on behalf of and to the mobile wireless communication device. A wireless receiver of the mobile wireless communication device used by the mobile wireless communication device to communicate with the wide area wireless network via a wide area communication connection is then deactivated. When the indication of a paging message intended for the mobile wireless communication device is to be delivered to the mobile wireless communication device having the deactivated wireless receiver, the wide area wireless network conveys the indication of the paging message via the proxy device, where the proxy device communicates the indication of the paging message via an interrupt based form of communication.

### FIELD OF THE INVENTION

The present invention relates generally to a system and method for managing a paging proxy for a mobile wireless communication device in a wide area wireless network, and more particularly, to the manner of communication between the paging proxy and the mobile wireless communication device including an interrupt based form of communication for relaying an indication of receipt of a paging message by the paging proxy on behalf of the mobile wireless communication device.

### BACKGROUND OF THE INVENTION

One of the factors that make cellular communications via a wireless communication device desirable is the ability make a communication connection with less concerns as to your present location, where the same device can generally connect wirelessly to the network infrastructure with less restrictions as to location while within the boundaries of a coverage area that can include multiple base station transmission sites. This allows one an ability to be mobile and still retain the capabilities of making and maintaining a communication connection via the network infrastructure.

Portable wireless communication capabilities are not only supported by a wireless transmit and receive architecture that involves the ability to transmit and receive a communication signal over distance without a wired connection, but also typically involves some form of power local to the device that can be used to support the operation of electronic circuits used by the device for support of its various functions. More specifically, mobile stations are often conventionally powered by a depletable energy source, such as a battery. In many instances, an at least partially or substantially fully depleted battery can then be recharged to further extend the ability of the battery to provide power to the various electronic circuits of the device. However, in order to be recharged, the device often needs to find an outlet of a main supply for making a wired connection, wherein during the recharging, the mobility of the device can be significantly restricted.

Correspondingly, device users will often get into the habit of recharging their devices during the night when they are sleeping, and they are generally not very mobile, so that in the morning the device will have a full charge at the start of the day. It is further desirable for the charge to last as long as possible thereafter, where ideally the charge will last at least until they are ready to go asleep again the following night in order to minimize the need to recharge their device during the day, when they are generally more active. One potential solution might be to add a sufficiently large battery to support the functioning of the device over the desired period of time. However, there is an equally desired trend to minimize the overall size and weight of the device, where a larger battery will often contribute to an increase in the overall size and weight of the device. Still further, as more features are incorporated into the device, an increased number of power drawing components, such as circuits, are often necessary to support the increase in functionality.

As such, there is a balance between decreasing the amount of power necessary to support an existing function with the increased power requirements associated with adding new, enhanced, or additional functionality, as well as a balance with the size of the battery and the ability of the battery to store and subsequently supply power. One such technique that has been used to try and reduce overall power consumption involves the use of a periodic paging signal constrained to a specific, reduced portion of the overall control channel, which can be used to alert the mobile device of an incoming call or communication. When waiting for an alert of an incoming call, the receiver of the mobile device can be activated for these portions, and, unless otherwise actively communicating with the network infrastructure, can be deactivated during the other portions of the channel in which no signal of interest is expected. However even during these reduced portions of the overall control channels, incoming pages for a particular mobile device can be rare. Correspondingly, the mobile device is often waking up to receive a paging signal during many instances, where there is no incoming page to be received.

In addition to being able to correspondingly activate/deactivate a portion of the circuitry of the mobile wireless communication device associated with managing a wireless communication connection with a wide area wireless network, the control circuitry of the mobile wireless communication device can sometimes implement interrupt technology, that will alert the control circuitry of an event that needs attention, even though the control circuitry is not actively monitoring the conditions that would trigger the need to react. For example, the control circuitry will have one or more interrupt inputs which when a predefined status in the values of the interrupt inputs is present will cause the attention of the control circuitry to be redirected to address the needs of the interrupt causing event. Generally, when an interrupt is detected on the one or more interrupt inputs of the control circuitry, interrupt handling circuitry will suspend current control circuitry activities, cause the control circuitry to save its present state, and cause the control circuitry to redirect itself to an interrupt handling state. As noted previously, the use of an interrupt to trigger the handling of a particular event, allows the control circuitry to avoid having to more actively monitor for the conditions causing an interrupt, thereby allowing the control circuit to more actively handle other tasks, and/or may allow the control circuitry to at least partially suspend portions of its and the device's operation.

From a network perspective, restricting paging messages to a particular portion of the control channel already has the possibility of adding some latency to the actual delivery of the paging message. Furthermore, because the page does not utilize a guaranteed delivery method, it may be necessary to repeat the message one or more times. Still further, because the network may not know with reasonable certainty where a mobile device is located, the page can often be sent to a tracking area for broadcast that can include 100 or more eNB's or base station type nodes, which represents potentially significant network resources.

Correspondingly, the present inventors have recognized that it would be beneficial to establish a paging proxy for a particular mobile device, whereby the paging proxy is capable of communicating with the particular mobile device separate from the wide area wireless communication network. In connection with establishing a paging proxy, the proxy can communicate with an associated mobile wireless communication device for purposes of informing the associated mobile wireless communication device of an indication of an incoming page, whereby the wide area wireless communication support circuitry in the mobile wireless communication device including a wireless receiver can be at least partially disabled in favor of an interrupt based form of local communication, which would enable the communication control circuitry of the mobile wireless communication device to avoid actively monitoring a communication channel for purposes of receiving an incoming paging signal and/or an indication of an incoming paging signal.

### SUMMARY OF THE INVENTION

The present invention provides a method for receiving and relaying a paging message via a paging proxy in a wide area wireless network. The method includes detecting a proxy device for acting as a paging proxy near a present position of a mobile wireless communication device, where the proxy device includes a communication connection with a network paging controller, and is adapted to interact with the mobile wireless communication device separately from a wide area communication connection used by the mobile device to communicate with the wide area wireless network. The mobile wireless communication device is then associated with the proxy device for receiving and relaying an indication of paging messages on behalf of and to the mobile wireless communication device. A wireless receiver of the mobile wireless communication device used by the mobile wireless communication device to communicate with the wide area wireless network via a wide area communication connection is deactivated. When the indication of a paging message intended for the mobile wireless communication device is to be delivered to the mobile wireless communication device having the deactivated wireless receiver, the wide area wireless network conveys an indication of the paging message to the mobile wireless communication device via the proxy device associated with the mobile wireless communication device, where the proxy device communicates to the mobile wireless communication device an indication that there is a paging message intended for the mobile wireless communication device via an interrupt based form of communication separately from the wide area communication connection associated with the wide area wireless network. The interrupt based form of communication produces an interrupt driven activation of the wireless receiver in the mobile wireless communication device.

In at least one embodiment, communicating the indication that there is a paging message intended for the mobile wireless communication device includes communicating the paging message to the mobile wireless communication device via the proxy device.

The present invention further provides a mobile wireless communication device. The mobile wireless communication device includes a proxy detection controller adapted for detecting a proxy device having a communication connection with a network paging controller and which is adapted for acting as a paging proxy, that is near a present position of the mobile wireless communication device. The mobile wireless communication device further includes a paging update request controller adapted for requesting a proxy device be used for receiving on behalf of and conveying to the mobile wireless communication device an indication of receipt of a paging message for the mobile wireless communication device. The mobile wireless communication device still further includes a wireless receiver adapted for communicating with the wide area wireless network via a wide area communication connection including receiving a paging message from a wide area wireless network, which can be selectively activated and deactivated. The mobile wireless communication device further includes a local receiver including a local interrupt based detector adapted for receiving separately from the wide area communication connection an interrupt based alert indicating receipt of a paging signal by the proxy device on behalf of the mobile wireless communication device. The mobile wireless communication device still further includes a communication controller, which is adapted to selectively deactivate the wide area wireless communication receiver when the detected nearby proxy device has been associated with the mobile wireless communication device for receiving paging signals on behalf of the mobile wireless communication device, and adapted to selectively activate the wide area wireless communication receiver when the indication of a received paging signal for the mobile wireless communication device from the detected nearby proxy device is received.

The present invention still further provides a proxy device for use in receiving a paging signal on behalf of a nearby mobile wireless communication device. The proxy device includes a wide area wireless network communication controller adapted for communicating with the wide area wireless network. The proxy device further includes a local communication controller adapted for interacting with the nearby mobile wireless communication device including receiving an association request comprising a request from the nearby mobile wireless communication device for proxy paging services. The local communication controller includes an interrupt based alert transmitter, which is adapted to support an interrupt driven communication connection with the mobile wireless communication device. Further yet, the proxy device includes a paging controller adapted for receiving a paging signal alert for the associated mobile wireless communication device via the wide area wireless network communication controller, and relaying an indication of the paging signal to the associated mobile wireless communication device via the interrupt based alert transmitter of the local communication controller.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a block diagram of an exemplary network environment in which the present invention is adapted to operate;

FIG. 2 is a block diagram of a paging controller for use in a wide area wireless network, illustrated in FIG. 1;

FIG. 3 is a block diagram of a mobile wireless communication device for use in a wide area wireless network, illustrated in FIG. 1;

FIG. 4 is a block diagram of a proxy device for use in conveying an indication of an incoming paging signal for an associated one or more mobile wireless communication devices using an interrupt based form of communication;

FIG. 5 is a partial view of an exemplary mobile wireless communication device in contact with a surface;

FIG. 6 is a back view of an exemplary mobile wireless communication device;

FIG. 7 is a flow diagram of a method for receiving and relaying a paging message via a paging proxy in a wide area wireless network; and

FIG. 8 is a flow diagram of a method for verifying the validity of the credentials being used by the proxy device.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

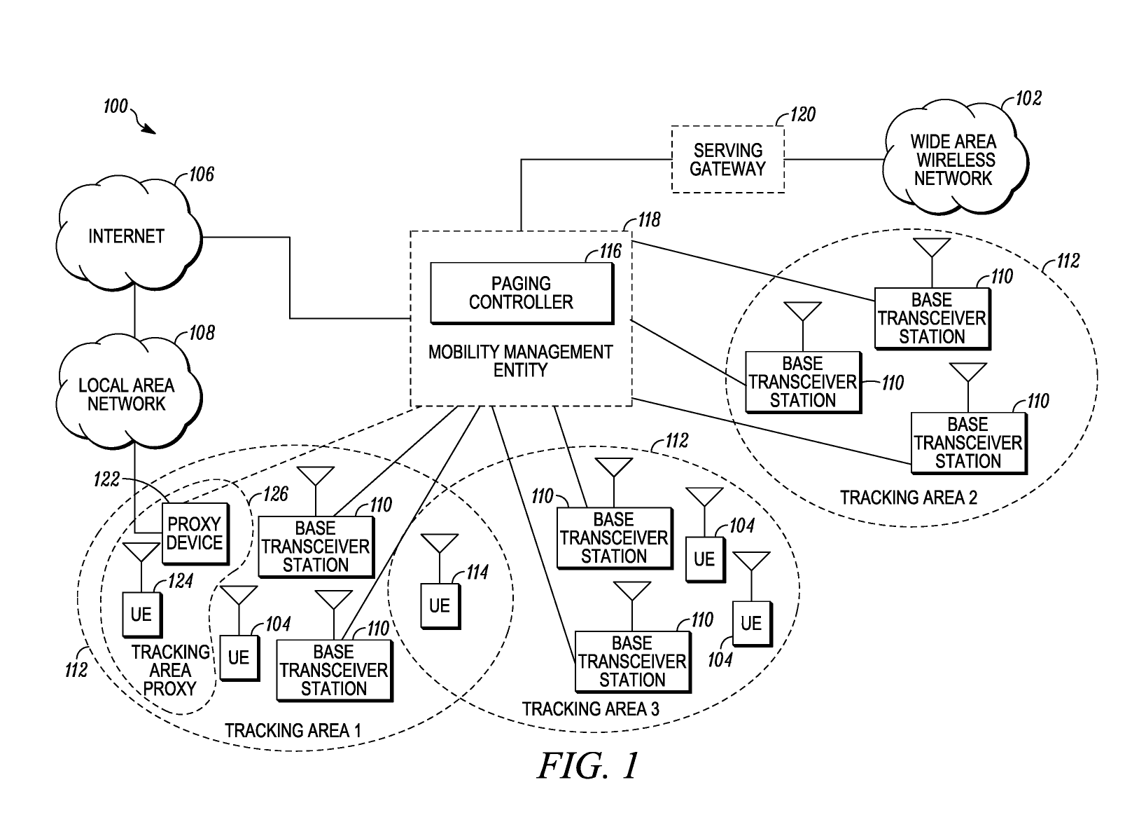

FIG. 1 illustrates a block diagram of an exemplary network environment 100 including a wide area wireless network in which a network infrastructure enables one or more mobile wireless communication devices 104, often referred to as user equipment (UE), to operate through wireless communications with the network and with each other. The illustrated exemplary network environment additionally includes the Internet 106, as well as one or more local area networks 108 of which some of the shown elements are a part and/or with which the shown elements can interact, either directly or indirectly.

In the illustrated embodiment, the wide area wireless network is a wireless cellular network, which includes geographically dispersed base transceiver stations 110, each base transceiver station generally corresponding to one or more cellular regions, which can then be grouped into various tracking areas 112. Each tracking area 112 corresponds to the particular group of base transceiver stations 112 and/or cellular regions that will be used to relay a paging signal when a particular mobile wireless communication device needs to be alerted as to an incoming call or message. In other words, when a mobile wireless communication device 104 is in an idle state, i.e. not actively communicating with the network infrastructure 102 of the wide area wireless network 102, the network maintains the current location of the mobile wireless communication device 104 at a tracking area level of granularity, as opposed to a cell level of granularity. While in an idle state, the mobile wireless communication device 104 will periodically wake up to monitor a control channel to determine if there is a paging message for the device 104, which would alert the device 104 as to a need to establish a more dedicated communication connection between the mobile wireless communication device 104 and the wide area wireless network 102.

In some instances, a mobile wireless communication device 114 can be in an area of overlap and/or proximate a boundary relative to multiple tracking areas 112. In such an instance, a wide area wireless network 102 may associate multiple tracking areas 112 with a particular mobile wireless communication device 114. While the grouping of base transceiver stations 110 for paging purposes in some networks are referred to as tracking areas, in other instances it is possible for the tracking area to alternatively be referred to as location areas, routing areas, or registration areas.

The paging of mobile wireless communication devices 104, is generally managed by a paging controller 116, which in the illustrated embodiment is incorporated as part of a mobility management entity 118. The paging controller 116 initiates the paging procedure by sending a paging message to the base transceiver stations 110, which are part of the tracking area(s) associated with the target mobile wireless communication device 104. The base transceiver stations 110 then broadcasts the paging message to the corresponding cellular transmission areas of the base transceiver stations that are part of the associated tracking area(s).

In at least some instances, the mobility management entity 118 will communicate with the rest of the wide area wireless network 102 via a serving gateway 120. For example, while in the illustrated example, the paging controller is shown as having a direct connection to the Internet 106, in some instances the paging controller will couple to the Internet via the serving gateway 120 and the portions of the wide area wireless network 102, which are not specifically shown, such as via a packet data network gateway.

In the illustrated embodiment, a proxy device 122 is illustrated, which is intended to serve as an alternative method via which a paging message can be communicated to one or more mobile wireless communication device 124. The proxy device 122 is intended to communicate with the mobile wireless communication device 124 via an alternative approach distinguishable from the approach via which the base transceiver stations 110 will typically convey a paging message to a mobile wireless communication device 104. This in turn will enable the mobile wireless communication device to deactivate its wireless receiver, which is associated with the wide area wireless network 102, and which would otherwise be activated at least periodically for purposes of receiving a potentially present paging message. It is envisioned that the proxy device 122 will be able to communicate at least an indication of a paging message with the mobile wireless communication device 124 via an alternative approach which will enable the paging message to be received by the mobile wireless communication device 124 in a manner which is intended to require less overall power.

In some instances, the indication of a paging message will be conveyed using a lower power form of wireless communication, which may require that the proxy device 122 be relatively closer to the corresponding mobile wireless communication device 124. For example, the proxy device 122 might communicate with the mobile wireless communication device 124 via a low power form of communication, such as Bluetooth Low Energy, infra red, Near Field Communication (NFC), or Radio Frequency Identification (RFID). In other instances, it may be necessary for the mobile wireless communication device 124 to be in physical contact with the proxy device 122. In instances where the mobile wireless communication device 124 is in physical contact with the proxy device 122, a vibrational source within the proxy device 122, such as a linear vibrator device or unbalanced mass vibrator, and a vibrational detector within the mobile wireless communication device 124, such as an accelerometer could be present for use in conveying a message, such as an indication of an incoming paging message, through the use of a distinctive vibrational pattern, which could be detected through the physical contact. In at least some instances, the accelerometer will be a part of a suite of sensors present in the mobile wireless communication device 124, which are adapted for detecting the relative movement of the device. The manner in which the proxy device 122 communicates with the mobile wireless communication device 124, in the present embodiment, can involve an interrupt based form of communication, which allows the communication to occur without requiring the mobile wireless communication device 124 to be actively or periodically listening for the communication. The manner of communication used by the proxy device could interact with circuit elements in the mobile wireless communication device 124, which will produce an interrupt that will alert the corresponding control circuitry of the presence of an incoming paging message.

While it is possible that the proxy device 122 could communicate with the paging controller 116 via a same or similar manner in which the paging controller 116 communicates paging messages to the base transceiver stations 110 for being broadcast in the corresponding tracking areas 112, it is envisioned that in some instances, the proxy device 122 will be coupled to the paging controller 116 via a broadband type connection. A broadband type connection in the present context refers to a type of connection over a backbone network which can include cable, optical and possible fixed wireless type communication links. A broadband type connection can include an Internet connection, which can be established via a local area network 108, such as through a local router using Ethernet for example, and/or a wireless LAN connection. In these and other instances, the communication connection between the paging controller and the proxy device can involve a wired connection.

While, in some instances, a change to existing tracking areas will not be necessary to support a conveyance of an indication of a paging message via a proxy device for a particular mobile wireless communication device 124, in other instances, the paging proxy can be added to an already existing tracking area 112, that is currently associated with the particular mobile wireless communication device 124, or can be added to a newly created tracking area 126, which can then be associated with the particular mobile wireless communication device 124.

A new tracking area can be created in such a way that when the paging proxy device 122 is established, the paging proxy device 122 can be the focus of future paging activities relative to the particular mobile wireless communication device 124. For example, this could be achieved by creating a new tracking area 126, which is associated with the mobile wireless communication device 124 where the proxy device 122 is the only member of the new tracking area 126. In turn this will avoid attempts by other base transceiver stations 110 to send a paging message to the mobile wireless communication device 124, especially where the wide area wireless receiver of the mobile wireless communication device 124 is known to have been deactivated, and any paging of the mobile wireless communication device 124 that might have been attempted by the one or more base transceiver stations 110 could not have been received. In this way, the wireless communication resources that may have been used in an attempt to send a paging message to the mobile wireless communication device 124 could be used for an attempt to send a paging message to another different device. However, in such an instance, it may be beneficial for the indication of a paging message that might be sent by the proxy device 122 to include a transmission of the paging message.

Alternatively, where the proxy device 122 is added to an already existing tracking area 112, an indication of a paging message for a particular mobile wireless communication device 124 might be used by the proxy device 122 to provide an alert to the mobile wireless communication device 124 of the presence of a paging message of interest. The mobile wireless communication device 124 could then reactivate its wireless receiver, so that a subsequent transmission of the paging message by a base transceiver station 110 could then be received. However, in such an instance, it is also possible that the indication of a paging message could include the paging message, thereby precluding the need to monitor for and receive a subsequent transmission of the message.

Furthermore, in instances where a newly created tracking area 126 is established to support the use of the proxy device 122 in sending a paging message to the mobile wireless communication device 124, it may be beneficial to allow for a backup tracking area, that could be used in the event that all attempts to contact the mobile wireless communication device 124 via the proxy device 122 have been exhausted without a response confirming receipt by the mobile wireless communication device 124 of the paging message or an indication thereof. For example, if the device 124 has moved out of communication range of the proxy device 122, attempts to contact the device via the proxy device 124 will fail. In such an instance, the backup tracking area would likely be the tracking area associated with the mobile wireless communication device 124 prior to the establishment of a tracking area 126 for a device 124 to be used as a paging proxy. For example relative to mobile wireless communication device 124, tracking area 1 in FIG. 1 might serve as a backup paging area.

It is also possible the proxy device 122 could function without needing to affect any existing tracking areas 112. In an example of such an instance, the mobile wireless communication device 124 could still deactivate its wireless receiver used to communicate with the wide area wireless network 102, and if the proxy device 122 has a wide area wireless receiver adapted for receiving a paging signal and the proxy device is already present in the area where the paging signal will be broadcast, then the proxy device 122 could detect the paging signal on behalf of the mobile wireless communication device 124 when such a signal is present. The proxy device 122 could then relay an indication of the received paging signal to the mobile wireless communication device 124 via a still active alternative interrupt based form of communication in the mobile wireless communication device 124, which is separate from the wide area wireless network 102.

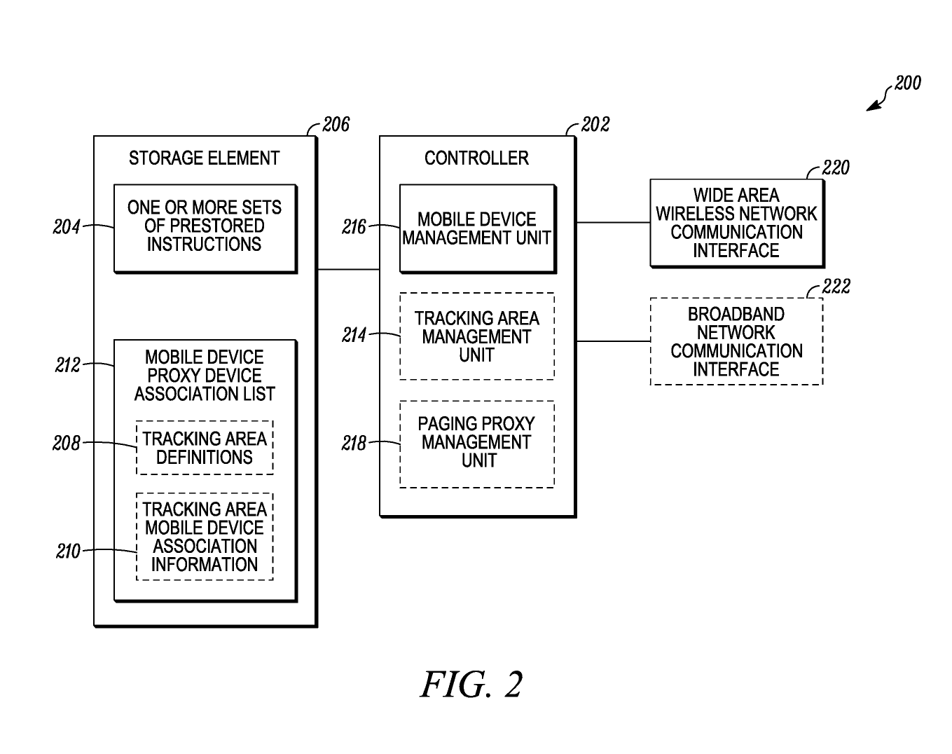

FIG. 2 illustrates a block diagram 200 of a paging controller 116 for use in a wide area wireless network, illustrated in FIG. 1. In at least some instances, as noted previously, the paging controller 116 can be incorporated as part of a mobility management entity 118. However, it is also possible that the paging controller 116 could be incorporated in another network element, or could be a standalone element. In the illustrated embodiment, the paging controller 116 includes a controller 202 or processor, which is adapted for managing at least some of the operation of the device. In some embodiments, the controller 202 could be implemented in the form of one or more microprocessors, which are adapted to execute one or more sets of pre-stored instructions 204, which may be used to form or implement the operation of at least part of one or more controller modules. The one or more sets of pre-stored instructions 204 may be stored in a storage element 206, which while shown as being a separate element could also be integrated as part of the controller 202, which may additionally or alternatively include some data storage capability for storing at least some of the prestored instructions for use with the controller 202.

The storage element 206 could include one or more forms of volatile and/or non-volatile memory, including conventional ROM, FLASH, EPROM, RAM, or EEPROM. The data storage capabilities may also include one or more forms of auxiliary storage, which is either fixed or removable, such as a hard drive, a floppy drive, or a memory stick. One skilled in the art will still further appreciate that still other further forms of storage elements could be used without departing from the teachings of the present disclosure. In the same or other instances, the controller 202 may additionally or alternatively incorporate state machines and/or logic circuitry, which can be used to implement at least partially, some of the modules and/or functionality associated with the controller 202.

In addition to the one or more sets of prestored instructions 204, the storage element 206 can additionally include a mobile device proxy device association list 212, which in conjunction with a mobile device management unit 216 of the controller 202, could serve to link a particular mobile wireless communication device 104 with a proxy device 122, such that when a paging message is intended for a particular mobile wireless communication device 104, the paging controller 116 can better determine how to forward the paging message to the mobile wireless communication device 124 via the associated proxy device 122, which may or may not involve the use of tracking areas.

Still further, the storage element 206 and, more specifically, the mobile device proxy association list 212 can include tracking area definitions 208, which in conjunction with a tracking area management unit 214 of the controller 202, could be used to identify the specific entities forming each of the tracking areas, wherein when a paging message needs to be communicated within a particular tracking area 112, the paging controller 116 knows which network entities, such as predefined groups of base transceiver stations need to be contacted for broadcasting the paging message. The storage element 206 can further include tracking area mobile device association information 210, which in conjunction with a mobile device management unit 216 of the controller 202, serves to link a particular mobile wireless communication device 104 with one or more particular tracking areas 112, such that when a paging message is intended for a particular mobile wireless communication device 124, the paging controller 116 can determine which tracking area(s) 112 to use. The tracking area definitions 208 and the tracking area mobile device association information 210 are more relevant where tracking areas are used by the paging controller 116 to communicate with the proxy device 122. Still further, the storage element 206 can include back up tracking area mobile device association information, which supports additional tracking areas that might be associated with a particular mobile wireless communication device should an attempt to contact a mobile wireless communication device via the primarily associated tracking area(s) fail.

Where tracking areas are used by the paging controller 116 to communicate with the proxy device, a paging proxy management unit 218 of the controller 202 is adapted for receiving tracking area update requests, where a corresponding request can include that a proxy device be associated with paging messages for a particular mobile wireless communication device 124. In connection with such a request, the proxy device 122 can be added to an already existing tracking area 112, or to a newly created tracking area 126. The tracking area associated with the mobile wireless communication device 124 can then be updated, if necessary, to reflect an association with the tracking area 112 or 126 that includes the proxy device 122.

When a request is received to associate a paging proxy device 122 with a particular mobile wireless communication device 124, it may be desirable for the paging controller 116 to be able to verify the validity of such a request including whether the request is acceptable to any affected mobile wireless communication devices 124. In order for the network to verify that the request is valid, the paging controller 116 may require that the proxy device 122 be identified by the mobile wireless communication device 124 as being authorized to act as a proxy for purposes of paging on behalf of the mobile wireless communication device 124. The paging controller 116 may further require that the proxy device 122 properly respond to a challenge response mechanism that confirms the credentials being used by the proxy device 122. More specifically, an authentication challenge could be generated wherein the proper response requires that it be based upon the credentials stored in a subscriber identity module associated with the corresponding mobile wireless communication device 124. Correspondingly, an authentication challenge could be received from the paging controller 116 by the affected mobile wireless communication device 124 via the proxy device 122. An authentication response could then be generated based upon the credentials in the subscriber identity module associated with the mobile wireless communication device 124. An authentication response could then be delivered to the paging controller 116 via the proxy device 122, where the response could be determined to be valid or not. In this way, the chances of an unauthorized attempt by a proxy device 122 to establish itself as a paging proxy device 122 for a particular mobile wireless communication device 124 can be reduced. It is further possible that the communications associated with verification of the proxy device 122 be secure and encrypted. In fact, in at least some instances, the communications between the mobile wireless communication device 124 and the proxy device 122 should be secure and encrypted, because this is where the security credentials of the mobile wireless communication device 124 to at least some degree are exposed to the proxy device 122.

The paging controller 116 further includes a wide area wireless network communication interface 220 via which the paging controller 116 can communicate with other network entities, such as the one or more base transceiver stations 110 as part of one or more tracking areas 112 via which a paging message can be communicated. The paging controller 116, in at least some instances, can additionally include a broadband network communication interface 222, such as an interface for communicating via a packet data network (i.e. the Internet 106), which may be separate from the wide area wireless network communication interface 220.

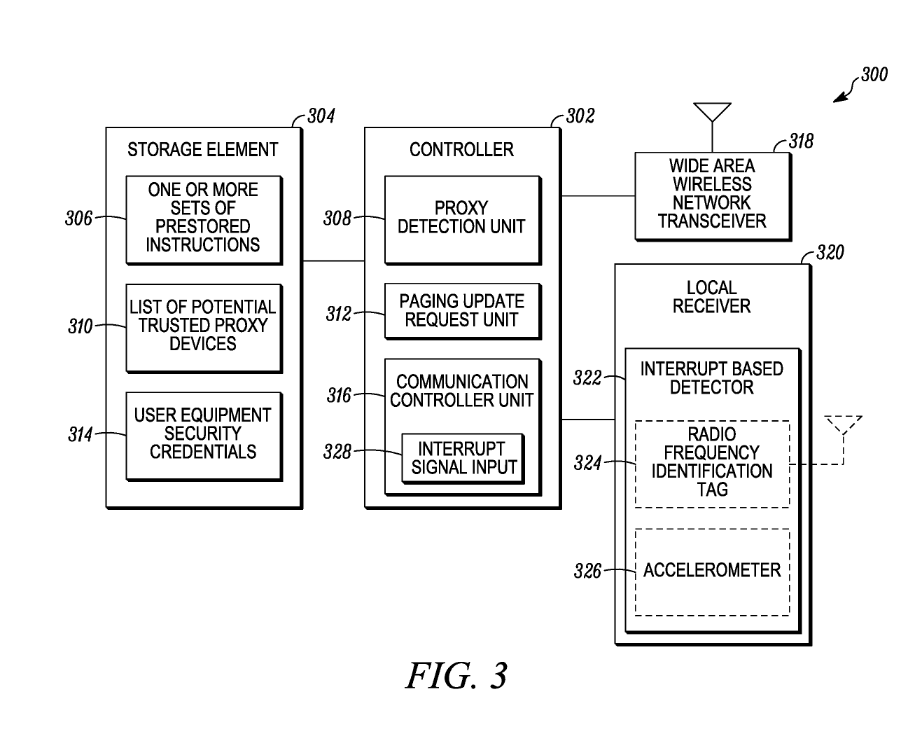

FIG. 3 illustrates a block diagram 300 of a mobile wireless communication device 124 for use in a wide area wireless network 102, illustrated in FIG. 1. Examples of a mobile wireless communication device 124 can include a radio frequency telephone, a tablet, a personal computer, a cellular telephone, a cordless telephone, a smartphone, a gaming device, a set top box and a personal digital assistant. In this enumeration of devices, it is assumed that all include a wide area wireless network transceiver. One skilled in the art will appreciate that the present invention could also be used with many other types of devices, without departing from the teachings of the present invention, as increasingly more and more devices are being equipped with wireless communication capabilities for which the present application may be suitable including instances where it is desirable for the device to communicate within a wide area wireless network, where it may be helpful to be able to alert the mobile wireless communication device of an incoming communication.

Similar to the paging controller 116, the mobile wireless communication device 124 includes a controller 302 or processor, which is adapted for managing at least some of the modem-related operation of the device, and a storage element 304, which could be used for storing one or more sets of pre-stored instructions 306 for use by the controller 302 as well as other information that might be used in managing at least some of the operation of the device. More specifically, the controller 302 includes a proxy detection unit 308, which is adapted for detecting the presence of a device that is capable and agreeable to operating as a proxy device 122 in support of paging operations for the mobile wireless communication device 124. The detection method could be implemented via various protocols, such as Bluetooth pairing procedures, or, if the device 124 is placed atop the proxy unit, a pressure sensor or infrared detection method could be used. Associated with detecting a suitable proxy device 122, the proxy detection unit 308 could maintain and use a list of potential trusted proxy devices 310, which could be located in the storage element 304.

In the illustrated embodiment, the controller 302 additionally includes a paging update request unit 312, which is adapted to request a proxy device 122 to be associated with the mobile wireless communication device 124 for receiving and relaying paging messages on behalf thereof. As noted previously, the use of a paging proxy device 122 could result in a verification process to ensure that the requested change relative to tracking areas is authorized. In connection with such a verification, the storage element 304 is additionally adapted to include user equipment security credentials 314, such as the type found in a subscriber identity module, which may be formed from all or parts of the storage element 304.

Still further, the controller 302 includes a communication controller unit 316, which is adapted to selectively activate and deactivate a wide area wireless network transceiver 318, as well as a local communication controller 320 depending upon whether the mobile wireless communication device 124 is intending to make more active use of a paging proxy device 122, or not. More specifically, the local communication controller 320 is adapted to selectively deactivate at least the receiver portion of the wide area wireless network transceiver 318, when a detected nearby proxy device 122 has been associated with the mobile wireless communication device 124 for receiving paging signals on behalf of the mobile wireless communication device 124. The local communication controller 320 is adapted to selectively activate the receiver portion of the wide are wireless network transceiver 318, when the indication of a paging signal for the mobile wireless communication device 124 from the nearby proxy device 122 is received.

The local communication controller 320 is generally adapted to manage the interaction between the mobile wireless communication device 124 and the proxy device 122 including communications, which are separate from a wide area wireless network communication connection that supports a more direct communication with the wide area wireless network 102. In at least some instances, the separate form of communication managed by the local communication controller 320 will include in the mobile wireless communication device 124 an interrupt based detector 322. Examples of an interrupt based detector 322 include a radio frequency identification tag 324, which is adapted to interact with a nearby RFID tag reader that could be incorporated into a proxy device 122, or a device which can detect a nearby vibration having a discernible pattern, such as an accelerometer 326. Where a vibration is to be detected, it is likely that the mobile wireless communication device 124 would need to be in physical contact either directly or indirectly with the source of the vibration. An interrupt based alert indicating receipt of a paging signal can be received by the controller 302 via one or more interrupt signal inputs 328. The local receiver 320 can be part of a local transceiver, which could additionally be adapted to convey to the proxy device 122 a request from the mobile wireless communication device 124, that the proxy device 122 receive paging messages on behalf of the mobile wireless communication device 124.

Similar to the controller 202 of the paging controller 116, illustrated in FIG. 2, in at least some embodiments, the controller 302 of the mobile wireless communication device 124 could be implemented in the form of one or more microprocessors, which are adapted to execute the one or more sets of pre-stored instructions 306, which may be used to form or implement the operation of at least part of the one or more controller modules. While the storage element 304, which can include the one or more sets of pre-stored instructions 306, are shown as being a separate element, the storage element 304 could also at least partially be integrated as part of the controller 302, which may additionally or alternatively include some data storage capability for storing at least some of the prestored instructions for use with the controller 302. The controller 302 may additionally or alternatively incorporate state machines and/or logic circuitry, which can be used to implement at least partially, some of the modules and/or functionality associated with the controller 302.

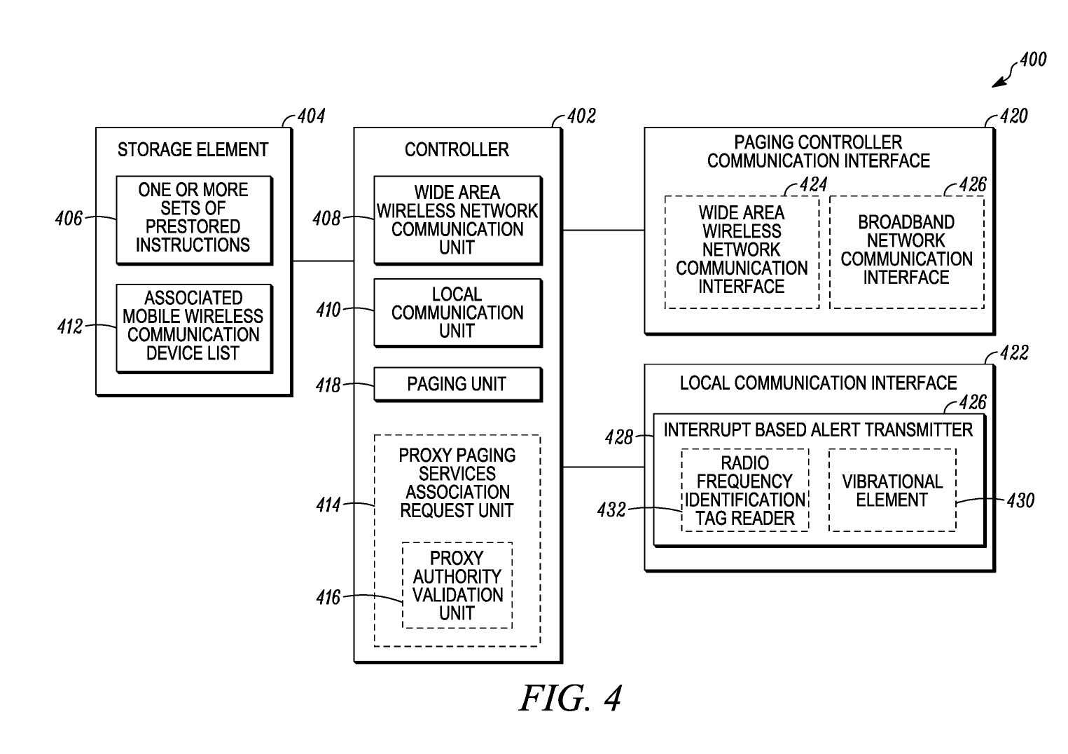

FIG. 4 illustrates a block diagram 400 of a proxy device 122 for use in conveying an indication of an incoming paging signal for an associated one or more mobile wireless communication devices 124. The proxy device 122 can involve a device capable of communicating with the paging controller 116 for receiving an indication of a paging message for one or more associated mobile wireless communication devices 124. In some instance, examples of the proxy device 122 can include a wireless local area network router, such as a Wi-Fi router. In other instances, examples of the proxy device can include a wireless charging station. In still further instances, the proxy device can be a wireless payment terminal or even another mobile wireless communication device.

Similar to the paging controller 116 and the mobile wireless communication device 124, the proxy device 122 includes a controller 402 or processor, which is adapted for managing at least some of the operation of the proxy device 122, and a storage element 404, which could be used for storing one or more sets of pre-stored instructions 406 for use by the controller 402 as well as other information that might be used in managing at least some of the operation of the proxy device 122. More specifically, the controller 402 includes a wide area wireless network communication unit 408, which is adapted for managing the communications between the proxy device 122 and the wide area wireless network 102 including the paging controller 116. The controller further includes a local communication unit 410, which is adapted for interacting with the nearby mobile wireless communication device(s) via a communication connection that is separate from the wide area communication connection used by the mobile wireless communication device 124 to communicate with the wide area wireless network 102. The proxy device 122 is adapted to receive a request for proxy paging services from a mobile wireless communication device 124 via the local communication unit 410. In at least some instances, upon receipt of such a request, a proxy paging services association request unit 414 of the controller 402 can be used to facilitate the proxy device 122 becoming associated with the mobile wireless communication device 124 for purposes of receiving and conveying a receipt of an indication of a paging message for an associated mobile wireless communication device(s). A list 412 of mobile wireless communication devices associated with the particular proxy device 122 can be maintained and updated, as necessary, in the storage element 404.

In at least some instances, as part of the becoming associated with a mobile wireless communication device, the controller 402 can include a proxy authority validation unit 416, which is adapted to verify the authority of the proxy device 122 to provide paging proxy services on behalf of the mobile wireless communication device 122 for which an association request is being made. In at least some instances, the proxy authority validation unit 416 will manage secure and encrypted communications between the proxy device 122, the mobile wireless communication device 124 and the paging controller 116, whereby credentials 314 derived from information stored in the subscriber identity module of the mobile wireless communication device 124 can be conveyed to the paging controller 116 to verify the authority of the proxy device 122 to act as a paging proxy on behalf of the mobile wireless communication device 124.

The controller 402 of the proxy device 122 further includes a paging unit 418, which is adapted for receiving a paging signal alert for an associated mobile wireless communication device 124 via the wide area wireless network communication unit 408, which interfaces with the paging controller 116 via a paging controller communication interface 420. The paging unit 418 is further adapted for forwarding an indication of an incoming paging signal to the associated mobile wireless communication device 124 via the local communication unit 410, which interfaces with the same via a local communication interface 422. In some instances, the indication of an incoming paging signal which is relayed to the associated mobile wireless communication device 124 will include the paging message. In other instances, the indication of an incoming paging signal which is relayed to the associated mobile wireless communication device 124 will prompt the associated mobile wireless communication device 124 to reactivate its wide area wireless network transceiver 318, so that the mobile wireless communication device 124 can receive a subsequent paging message transmission more directly from the wide area wireless network 102.

In some instances, the paging controller communication interface 420 will include a wide area wireless network communication interface 424 via which the indication of a paging message for any and all associated mobile wireless communication devices can be received from the paging controller 116. The wide area wireless network communication interface 424 could receive messages from the paging controller 116 similar to the manner in which a base transceiver station 110 in a tracking area 112 will receive an indication of a paging message for broadcasting in the respective tracking area 112. In some instances, the paging controller communication interface 420 will include a broadband network communication interface 426 via which the indication of a paging message for any and all associated mobile wireless communication devices can be received from the paging controller 116. As noted previously, a broadband type connection in the present context refers to a type of connection over a backbone network which can include cable, optical and possibly fixed wireless type communication links, and can include an Internet or an Internet type (i.e. packet data) connection. In the same or other instances, the paging controller communication interface 420 can include a wired connection to the wide area wireless network 102.

In the illustrated embodiment, the local communication interface includes an interrupt based alert transmitter 428, which is adapted to support an interrupt driven communication connection with the mobile wireless communication device 124. In other words, the interrupt based alert transmitter 428 is intended to employ a form of communication that matches up with a form of receiver in the mobile wireless communication device, that upon receipt of the signal will generate an interrupt in the mobile wireless communication device 124 in order to prompt the device 124 to respond to the incoming signal. It is not expected that the transmission of a signal originating in the proxy device would be the result of an interrupt being processed in the proxy device, but it could. In at least some instances, the interrupt based alert transmitter 428 can include a vibrational element 430, which can be used to convey a distinctive vibrational pattern to another device in direct or indirect physical contact with the proxy device 122, which can be detected by corresponding structure in the other device, such as an accelerometer 326 or other related structure adapted for sensing a vibration. In at least some other instances, the interrupt based alert transmitter 428 can include a radio frequency identification tag reader 432 for interaction with a radio frequency tag, which might be a part of or associated with a nearby device. One skilled in the art will recognize that other forms of conveying an interrupt based alert to another nearby device are possible without departing from the teachings of the present invention. In each instance, receipt of the corresponding interrupt based alert can be used to generate an interrupt signal in the nearby device, such as the mobile wireless communication device 124 for which the proxy device 122 is providing a paging proxy service.

Similar to the controller 202 of the paging controller 116, illustrated in FIG. 2, and the controller 302 of the mobile wireless communication device 124, illustrated in FIG. 3, in at least some embodiments, the controller 402 of the proxy device 122 can be implemented in the form of one or more microprocessors, which are adapted to execute the one or more sets of pre-stored instructions 406, which may be used to form or implement the operation of at least part of the one or more controller modules. While the storage element 404, which can include the one or more sets of pre-stored instructions 406, are shown as being a separate element, the storage element 404 could also at least partially be integrated as part of the controller 402, which may additionally or alternatively include some data storage capability for storing at least some of the prestored instructions for use with the controller 402. The controller 402 may additionally or alternatively incorporate state machines and/or logic circuitry, which can be used to implement at least partially, some of the modules and/or functionality associated with the controller 402.

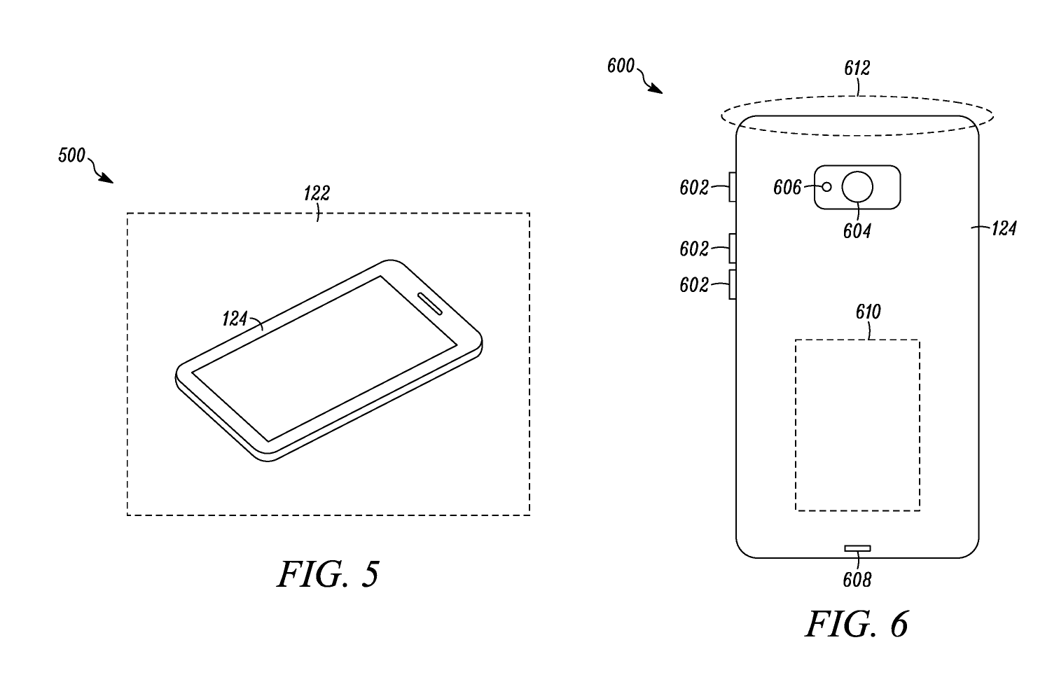

FIG. 5 illustrates a partial view 500 of an exemplary mobile wireless communication device 124 in contact with a surface, which might be a part of or in contact with a proxy device 122. Through their direct or indirect physical contact, a vibration generated in one has the potential for being sensed in the other. In the illustrated embodiment, the surface could be a surface of another device, such as wireless charging station.

FIG. 6 illustrates a back view 600 of an exemplary mobile wireless communication device 124. The back of the device 124 includes three physical user actuatable side buttons 602, which would also be visible as well as accessible from the front. The exemplary hand held electronic device additionally includes a back side facing camera 604 with a flash 606, as well as a serial bus port 608, which is generally adapted for receiving a cable connection, which can be used to receive data and/or power signals. Still further, the illustrated embodiment includes an area 610 proximate the back side surface, within which one or more loop antennas for supporting the presence of a radio frequency identification tag. In other devices, the antenna for supporting a radio frequency identification tag can be positioned at other locations around the device, such as near the top 612 of the device 124. The one or more radio frequency identification tag antennas are often located internal to the device, often just below the surface of the device 124, such as the back side or top surface. The use of a radio frequency identification tag and corresponding reader allows for the two devices to convey a signal in support of the interrupt based communication without the two devices needing to be in physical contact with one another.

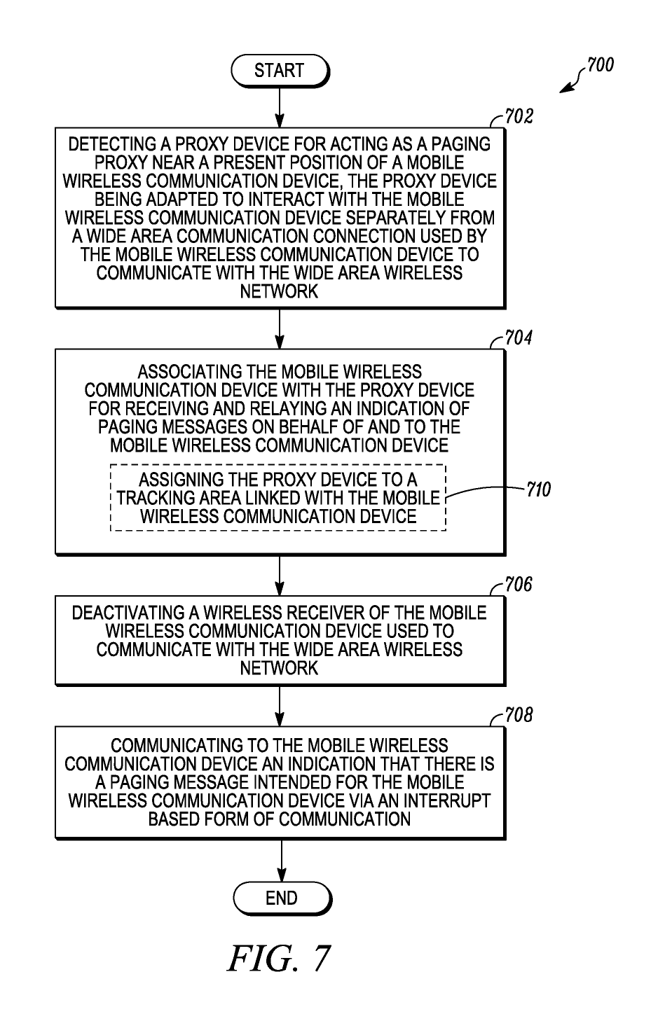

FIG. 7 illustrates a flow diagram 700 of a method for receiving and relaying a paging message via a paging proxy in a wide area wireless network. The method includes detecting 702 a proxy device 122 for acting as a paging proxy near a present position of the mobile wireless communication device 124, where the proxy device 122 includes a communication connection with a network paging controller 116, and is adapted to interact with the mobile wireless communication device 124 separately from the wide area communication connection used by the mobile wireless communication device 124 to communicate with the wide area wireless network 102. The mobile wireless communication device 124 is then associated 704 with the proxy device 122 for receiving and relaying an indication of paging messages on behalf of and to the mobile wireless communication device 124. A wireless receiver 318 used by the mobile wireless communication device 124 to communicate with the wide area wireless network 102 via a wide area communication connection is then deactivated 706, such that when a paging message intended for the mobile wireless communication device 124 is to be delivered to the mobile wireless communication device 124 having the deactivated wireless receiver 318, the wide area wireless network 102 conveys the indication of the paging message to the mobile wireless communication device 124 via the proxy device 122 associated with the mobile wireless communication device. An indication that there is a paging message intended for the mobile wireless communication device 124 can then be communicated 708 by the proxy device 122 to the mobile wireless communication device 124 via an interrupt based form of communication separate from the wide area communication connection associated with the wide area wireless network, which can produce an interrupt driven activation of the wireless receiver in the mobile communication device.

In at least some instances, the mobile wireless communication device 124 is associated with a proxy device 122 through an assignment 710 of the proxy device to a tracking area linked with the mobile wireless communication device 124.

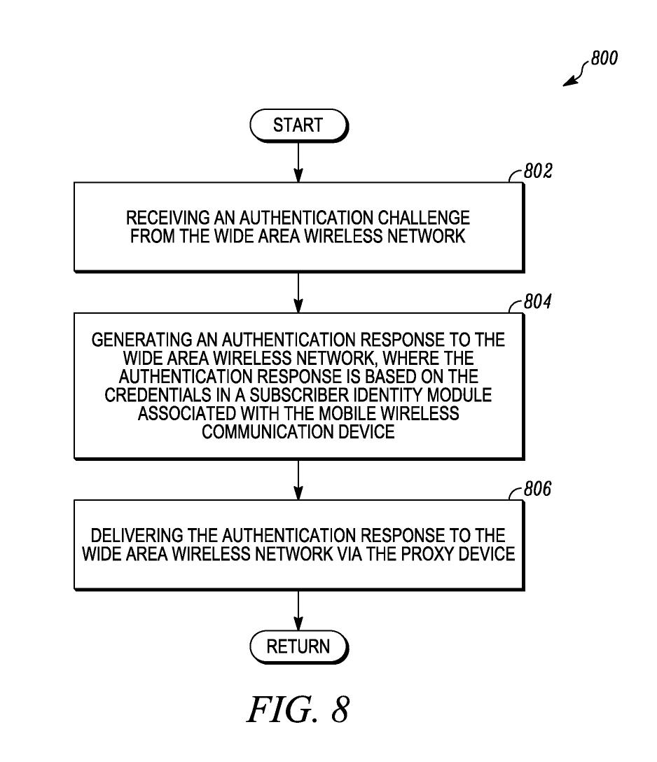

FIG. 8 illustrates a flow diagram 800 of a method for verifying the validity of the credentials being used by the proxy device 122, which can be performed after a paging proxy device 122 is detected 702, but before the paging proxy device 122 is assigned 704 to the mobile wireless communication device 124 for providing paging proxy services. Such a verification can be performed to ensure that the proxy device 122 is authorized to act as a paging proxy on behalf of the mobile wireless communication device 124.

More specifically, the verification of the validity of the credentials being used by the proxy device 122 includes the mobile wireless communication device 124 receiving 802 an authentication challenge from the wide area wireless network 102 via the proxy device 122. An authentication response to the wide area wireless network 102 is then generated 804, wherein the authentication response is generated based on the credentials 314 stored in the mobile wireless communication device 124, such as in a subscriber identity module associated with the mobile wireless communication device 124. The authentication response is then delivered 806 to the wide area wireless network 102 via the proxy device 122. The communication between the mobile wireless communication device and the proxy device can be effected via a number of well-known methods, such as Bluetooth or Wi-Fi peer to peer messaging. In this way, the wide area network 102 can be better assured that the proxy device 122 is acting under authority from the mobile wireless communication device 124.

By using a paging proxy, a mobile wireless communication device can maintain its wide area wireless network transceiver in a deactivated state for even longer periods of time during which it might be receiving a paging message from the wide area wireless network, in favor of a lower power form of alert for receiving an indication of an incoming paging message. In this way, the amount of power used by a mobile wireless communication device during idle mode may be further reduced.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for receiving and relaying a paging message via a paging proxy in a wide area wireless network, the method comprising:
detecting a proxy device for acting as a paging proxy near a present position of a mobile wireless communication device, where the proxy device includes a communication connection with a network paging controller, and is adapted to interact with the mobile wireless communication device separately from a wide area communication connection used by the mobile device to communicate with the wide area wireless network;
associating the mobile wireless communication device with the proxy device for receiving and relaying an indication of paging messages on behalf of and to the mobile wireless communication device; and
deactivating a wireless receiver of the mobile wireless communication device used by the mobile wireless communication device to communicate with the wide area wireless network via a wide area communication connection;
wherein when the indication of a paging message intended for the mobile wireless communication device is to be delivered to the mobile wireless communication device having the deactivated wireless receiver, the wide area wireless network conveys an indication of the paging message to the mobile wireless communication device via the proxy device associated with the mobile wireless communication device, where the proxy device communicates to the mobile wireless communication device an indication that there is a paging message intended for the mobile wireless communication device via an interrupt based form of communication separately from the wide area communication connection associated with the wide area wireless network, the interrupt based form of communication produces an interrupt driven activation of the wireless receiver in the mobile wireless communication device.

2. A method in accordance with claim 1, wherein communicating the indication that there is a paging message intended for the mobile wireless communication device includes communicating the paging message to the mobile wireless communication device via the proxy device.

3. A method in accordance with claim 1, wherein when the indication that there is a paging message intended for the mobile wireless communication device is received by the mobile wireless communication device via the proxy device, the mobile wireless communication device activates the wireless receiver of the mobile wireless communication device for communicating with the wide area wireless network via a wide area communication connection, and establishes a wide area communication connection with the wide area wireless network.

4. A method in accordance with claim 3, wherein the interrupt based form of communication includes an interaction between a radio frequency identification reader associated with the proxy device and a radio frequency identification tag associated with the mobile wireless communication device.

5. A method in accordance with claim 3, wherein the interrupt based form of communication includes detection of a distinctive surface vibration pattern proximate the mobile wireless communication device.

6. A method in accordance with claim 1, wherein the wireless receiver of the mobile communication device is incorporated as part of a wireless transceiver.

7. A method in accordance with claim 1, wherein, when associating the mobile wireless communication device with the proxy device for receiving and relaying an indication of paging messages on behalf of and to the mobile wireless communication device, the proxy device is assigned to a tracking area, which is linked with the mobile wireless communication device.

8. A method in accordance with claim 7, wherein associating the mobile wireless communication device with the proxy device includes creating a new tracking area, which is linked with the mobile wireless communication device, and assigning the proxy device to the newly created tracking area.

9. A method in accordance with claim 7, wherein associating the mobile wireless communication device with the proxy device includes assigning the proxy device to a particular tracking area already linked with the mobile wireless communication device.

10. A method in accordance with claim 1, wherein as part of associating the mobile wireless communication device with the proxy device, a controller of the wide area wireless network verifies whether credentials being used by the proxy device are valid.

11. A method in accordance with claim 10, wherein the credentials being used by the proxy device includes credentials associated with the mobile wireless communication device for which the proxy device will be serving as a paging proxy.

12. A mobile wireless communication device comprising:
a proxy detection controller adapted for detecting a proxy device having a communication connection with a network paging controller and which is adapted for acting as a paging proxy, that is near a present position of the mobile wireless communication device;
a paging update request controller adapted for requesting a proxy device be used for receiving on behalf of and conveying to the mobile wireless communication device an indication of receipt of a paging message for the mobile wireless communication device;
a wireless receiver adapted for communicating with the wide area wireless network via a wide area communication connection including receiving a paging message from a wide area wireless network, which can be selectively activated and deactivated;
a local receiver including a local interrupt based detector adapted for receiving separately from the wide area communication connection an interrupt based alert indicating receipt of a paging signal by the proxy device on behalf of the mobile wireless communication device; and
a communication controller, which is adapted to selectively deactivate the wide area wireless communication receiver when the detected nearby proxy device has been associated with the mobile wireless communication device for receiving paging signals on behalf of the mobile wireless communication device; and adapted to selectively activate the wide area wireless communication receiver when the indication of a received paging signal for the mobile wireless communication device from the detected nearby proxy device is received.

13. A mobile wireless communication device in accordance with claim 12, wherein the local interrupt based detector comprises an interrupt driven sensor for receiving an indication of a paging signal from the detected nearby proxy device.

14. A mobile wireless communication device in accordance with claim 13, wherein the interrupt driven sensor includes a sensor for detecting the vibration of a nearby surface to which the mobile wireless communication device is proximate.

15. A mobile wireless communication device in accordance with claim 12, wherein the local interrupt based detector includes a radio frequency identification tag adapted for interacting with a nearby radio frequency identification reader.

16. A mobile wireless communication device in accordance with claim 12, wherein the local receiver is part of a local transceiver, which is adapted to convey to the proxy device a request that the proxy device receive messages on behalf of the mobile wireless communication device.

17. A proxy device for use in receiving a paging signal on behalf of a nearby mobile wireless communication device, the proxy device comprising:
a wide area wireless network communication controller adapted for communicating with the wide area wireless network;
a local communication controller adapted for interacting with the nearby mobile wireless communication device including receiving an association request comprising a request from the nearby mobile wireless communication device for proxy paging services, and the local communication controller including an interrupt based alert transmitter, which is adapted to support an interrupt driven communication connection with the mobile wireless communication device; and
a paging controller adapted for receiving a paging signal alert for the associated mobile wireless communication device via the wide area wireless network communication controller, and relaying an indication of the paging signal to the associated mobile wireless communication device via the interrupt based alert transmitter of the local communication controller.

18. A proxy device in accordance with claim 17, wherein the wide area wireless network communication controller includes a wired connection to the wide area wireless network.

19. A proxy device in accordance with claim 17, wherein the wide area wireless network communication controller includes a broadband connection to the wide area wireless network.

20. A proxy device in accordance with claim 17, wherein the proxy device is assigned to a tracking area, which is linked with the mobile wireless communication device.
